(19) United States
(12) Patent Application Publication
(10) Pub. No.: US 2025/0113272 A1
(43) Pub. Date: Apr. 3, 2025

(54) METHOD AND APPARATUS FOR LAYER 1/LAYER 2 TRIGGERED MOBILITY IN WIRELESS NETWORKS

(71) Applicant: SHARP KABUSHIKI KAISHA, Sakai City (JP)

(72) Inventors: Chia-Hung LIN, Taipei (TW); Mei-Ju SHIH, Taipei (TW); Yen-Hua LI, Taipei (TW); Wan-Chen LIN, Taipei (TW); He-Hsuan LIU, Taipei (TW)

(21) Appl. No.: 18/901,489

(22) Filed: Sep. 30, 2024

Related U.S. Application Data
(60) Provisional application No. 63/586,206, filed on Sep. 28, 2023.

(51) Int. Cl. H04W 36/08; H04W 56/00; H04W 74/0833

(52) U.S. Cl. CPC H04W 36/08; H04W 56/0045; H04W 74/0833

(57) ABSTRACT

A method performed by a User Equipment (UE) for Layer 1/Layer 2 Triggered Mobility (LTM) is provided. The method receives, from a source cell, a Cell Switch Command (CSC) Medium Access Control (MAC) Control Element (CE), the CSC MAC CE indicating a target cell, Timing Advance (TA) information, and a Transmission Configuration Indicator (TCI) state. The method determines whether the TA information is valid. In a case that the TA information is valid, the method determines a pathloss based on a pathloss reference signal associated with the TCI state. In a case that the TA information is not valid, the method determines whether the CSC MAC CE includes Contention-Free Random Access (CFRA) information, and then determines the pathloss based on a Synchronized Signal Block (SSB) indicated in the CFRA information in a case that the CSC MAC CE includes the CFRA information.

### CROSS-REFERENCE TO RELATED APPLICATION(S)

The present disclosure claims the benefit of and priority to U.S. Provisional Patent Application Ser. No. 63/586,206, filed on Sep. 28, 2023, entitled “METHODS FOR ENHANCING THE RELIABILITY OF TA ACQUISITION SCHEMES FOR LTM,” the content of which is hereby incorporated herein fully by reference into the present disclosure for all purposes.

### FIELD

The present disclosure is related to wireless communication and, more specifically, to a User Equipment (UE), Base Station (BS), and method for Layer 1/Layer 2 Triggered Mobility (LTM) in the wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there exists a need for further improvements in the next-generation wireless communication systems, such as improvements in Layer 1/Layer 2 Triggered Mobility (LTM).

### SUMMARY

The present disclosure is related to a UE and a method for Layer 1/Layer 2 Triggered Mobility (LTM) in the wireless communication networks.

In a first aspect of the present disclosure, a method performed by a UE for LTM is provided. The method includes receiving, from a source cell, a Cell Switch Command (CSC) Medium Access Control (MAC) Control Element (CE), the CSC MAC CE indicating a target cell, Timing Advance (TA) information, and a Transmission Configuration Indicator (TCI) state; determining whether the TA information is valid; determining a pathloss based on a pathloss reference signal associated with the TCI state in a case that the TA information is valid; determining whether the CSC MAC CE includes Contention-Free Random Access (CFRA) information in a case that the TA information is not valid; and determining the pathloss based on a Synchronized Signal Block (SSB) indicated in the CFRA information in a case that the CSC MAC CE includes the CFRA information.

In some implementations of the first aspect, the method further includes: determining to perform a Random-Access Channel-less (RACH-less) cell switch procedure in a case that the TA information is valid. Determining the pathloss based on the pathloss reference signal associated with the TCI state includes determining the pathloss during the RACH-less cell switch procedure.

In some implementations of the first aspect, the pathloss determined based on the pathloss reference signal associated with the TCI state during the RACH-less cell switch procedure is associated with a transmission power of a Physical Uplink Shared Channel (PUSCH) transmission to the target cell.

In some implementations of the first aspect, the PUSCH transmission is a first uplink transmission to the target cell after receiving the CSC MAC CE from the source cell.

In some implementations of the first aspect, the pathloss reference signal is provided by a pathlossReferenceRS field.

In some implementations of the first aspect, the pathloss determined based on the SSB indicated in the CFRA information is associated with a transmission power of a Physical Random-Access Channel (PRACH) triggered by the CSC MAC CE.

In some implementations of the first aspect, the method further includes performing a Random-Access procedure with the target cell based on the transmission power of the PRACH.

In a second aspect of the present disclosure, a UE for LTM is provided. The UE includes at least one processor and at least one non-transitory computer-readable medium that is coupled to the at least one processor and that stores one or more computer-executable instructions. The computer-executable instructions, when executed by the at least one processor, cause the UE to: receive, from a source cell, a CSC MAC CE, the CSC MAC CE indicating a target cell, TA information, and a TCI state; determine whether the TA information is valid; determine a pathloss based on a pathloss reference signal associated with the TCI state in a case that the TA information is valid; determine whether the CSC MAC CE includes CFRA information in a case that the TA information is not valid; and determine the pathloss based on an SSB indicated in the CFRA information in a case that the CSC MAC CE includes the CFRA information.

In some implementations of the second aspect, the one or more computer-executable instructions, when executed by the at least one processor, further cause the UE to: determine to perform a RACH-less cell switch procedure in a case that the TA information is valid. Determining the pathloss based on the pathloss reference signal associated with the TCI state includes determining the pathloss during the RACH-less cell switch procedure.

In some implementations of the second aspect, the pathloss determined based on the pathloss reference signal associated with the TCI state during the RACH-less cell switch procedure is associated with a transmission power of a PUSCH transmission to the target cell.

In some implementations of the second aspect, the PUSCH transmission is a first uplink transmission to the target cell after receiving the CSC MAC CE from the source cell.

In some implementations of the second aspect, the pathloss reference signal is provided by a pathlossReferenceRS field.

In some implementations of the second aspect, the pathloss determined based on the SSB indicated in the CFRA information is associated with a transmission power of a PRACH triggered by the CSC MAC CE.

In some implementations of the second aspect, the one or more computer-executable instructions, when executed by the at least one processor, further cause the UE to perform a Random-Access procedure with the target cell based on the transmission power of the PRACH.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process performed by a User Equipment (UE) for Layer 1/Layer 2 Triggered Mobility (LTM), according to an example implementation of the present disclosure.

FIG. 2 is a block diagram illustrating a node for wireless communication, according to an example implementation of the present disclosure.

### DETAILED DESCRIPTION

Some of the abbreviations used in the present disclosure include:

| Abbreviation | Full name |
|---|---|
| 3GPP | 3^{rd} Generation Partnership Project |
| 5G | 5^{th} Generation |
| ACK | Acknowledgment |
| BS | Base Station |
| BWP | Bandwidth Part |
| C-RNTI | Cell RNTI |
| CA | Carrier Aggregation |
| CBRA | Contention Based Random Access |
| CC | Component Carrier |
| CCE | Control Channel Element |
| CE | Control Element |
| CFRA | Contention Free Random Access |
| CG | Configured Grant |
| CHO | Conditional Handover |
| CORESET | Control Resource Set |
| CRC | Cyclic Redundancy Check |
| CS-RNTI | Configured Scheduling RNTI |
| CSS | Common Search Space |
| CSI | Channel State Information |
| CSI-RS | Channel State Information Reference Signal |
| DAPS | Dual Active Protocol Stack |
| DC | Dual Connectivity |
| DCI | Downlink Control Information |
| DL | Downlink |
| DM-RS | Demodulation Reference Signal |
| DRB | Data Radio Bearer |
| DRX | Discontinuous Reception |
| DTX | Discontinuous Transmission |
| EPRE | Energy Per Resource Element |
| E-UTRA | Evolved Universal Terrestrial Radio Access |
| FDD | Frequency Division Duplex |
| FR | Frequency Range |
| FWA | Fixed Wireless Access |
| GC-PDCCH | Group Common Physical Downlink Control Channel |
| HARQ | Hybrid Automatic Repeat Request |
| HARQ-ACK | HARQ Acknowledgement |
| HO | Handover |
| ID | Identifier |
| IE | Information Element |
| IIoT | Industrial Internet of Things |
| L1/L2/L3 | Layer 1/Layer 2/Layer 3 |
| LCP | Logical Channel Prioritization |
| LTE | Long Term Evolution |
| LTM | Layer 1/Layer 2 Triggered Mobility |
| LSB | Least Significant Bit |
| MAC | Medium Access Control |
| MAC CE | MAC Control Element |
| MCG | Master Cell Group |
| MCS | Modulation and Coding Scheme |
| MN | Master Node |
| MIMO | Multi-input Multi-output |
| MSB | Most Significant Bit |
| multi-TRP | multiple Transmission and Reception Point |
| NACK | Negative Acknowledgement |
| NAS | Non Access Stratum |
| NDI | New Data Indicator |
| NES | Network Energy Saving |
| NG-RAN | Next Generation RAN |
| non-CB | non-CodeBook |
| NR | New Radio |
| NUL | Normal Uplink |
| NW | Network |
| NZP | Non-Zero Power |
| OFDM | Orthogonal Frequency Division Multiplexing |
| PBCH | Physical Broadcast Channel |
| PCell | Primary Cell |
| PCI | Physical Cell Identifier |
| PDCCH | Physical Downlink Control Channel |
| PDSCH | Physical Downlink Shared Channel |
| PDU | Protocol Data Unit |
| PH | Power Headroom |
| PHR | Power Headroom Report |
| PHY | Physical (layer) |
| P-MPR | Power management Maximum Power Reduction |
| PRACH | Physical Random Access Channel |
| PSCell | Primary SCG Cell |
| PTAG | Primary Timing Advance Group |
| PTRS | Phase Tracking Reference Signal |
| PUCCH | Physical Uplink Control Channel |
| PUSCH | Physical Uplink Shared Channel |
| QCL | Quasi Co-Location |
| QoS | Quality of Service |
| RA | Random Access |
| RACH | Random Access Channel |
| RAN | Radio Access Network |
| RAR | Random Access Response |
| Rel | Release |
| RF | Radio Frequency |
| RLF | Radio Link Failure |
| RMSI | Remaining Minimum System Information |
| RNTI | Radio Network Temporary Identifier |
| RRC | Radio Resource Control |
| RS | Reference Signal |
| RSSI | Reference Signal Strength Indication |
| RSRP | Reference Signal Received Power |
| RSRQ | Reference Signal Received Quality |
| RV | Redundancy Version |
| Rx | Reception |
| SCell | Secondary Cell |
| SCG | Secondary Cell Group |
| SDM | Spatial Division Multiplexing |
| SFN | Single-Frequency Network |
| SI | System Information |
| SIB | System Information Block |
| SINR | Signal to Interference plus Noise Ratio |
| SL | Sidelink |
| SN | Secondary Node |
| SpCell | Special Cell |
| SPS | Semi-Persistent Scheduling |
| SR | Scheduling Request |
| SRS | Sounding Reference Signal |
| SSB | Synchronization Signal Block |
| STAG | Secondary Timing Advance Group |
| STxMP | Simultaneous Transmission with Multi-Panels |
| SUL | Supplementary Uplink |
| TA | Timing Advance |
| TAG | Timing Advance Group |
| TB | Transport Block |
| TBS | Transport Block Size |
| TCI | Transmission Configuration Indicator |
| TDD | Time Division Duplex |
| TDM | Time Division Multiplexing |
| TPC | Transmission Power Control |
| TPMI | Transmit Precoder Matrix Indication |
| TRP | Transmission Reception Point |
| TR | Technical Report |
| TRI | Transmit Rank Indication |
| TS | Technical Specification |
| Tx | Transmission |
| UE | User Equipment |
| UL | Uplink |
| URLLC | Ultra-Reliable and Low-Latency Communication |
| USS | UE-Specific Search Space |
| V2X | Vehicle to Everything |
| WCDMA | Wideband Code Division Multiple Access |
| WG | Working Group |
| WI | Working Item |
| ZP-CSI-RS | Zero Power CSI-RS |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface. Although the gNB is used as an example in some implementations within the present disclosure, it should be noted that the disclosed implementations may also be applied to other types of base stations.

The BS may be operable to provide radio coverage to a specific geographical area using multiple cells forming the RAN. The BS may support the operations of the cells. Each cell may be operable to provide services to at least one UE within its radio coverage.

Each cell (may often referred to as a serving cell) may provide services to one or more UEs within the cell's radio coverage, such that each cell schedules the DL (and optionally UL resources) to at least one UE within its radio coverage for DL (and optionally UL packet transmissions from the UE). The BS may communicate with one or more UEs in the radio communication system via the cells.

A cell may allocate sidelink (SL) resources for supporting the Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR may support flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically, Low-Density Parity-Check (LDPC) code and Polar Code. The coding scheme adaption may be configured based on channel conditions and/or service applications.

At least the DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

In some implementations, all the designs/embodiment/implementations introduced within this disclosure are not limited to be applied for dealing with the problems discussed within this disclosure. For example, the described embodiments may be applied to solve other problems that exist in the RAN of wireless communication systems. In some implementations, all of the numbers listed within the designs/embodiment/implementations introduced within this disclosure are just examples and for illustration, for example, of how the described methods are executed.

A DL RRC message in the present disclosure may include, but is not limited to, an RRC reconfiguration message (RRCReconfiguration), an RRC resume message (RRCResume), an RRC reestablishment message (RRCReestablishment), an RRC setup message (RRCSetup) or any other DL unicast RRC message.

In some implementations, “a specific configuration is per UE configured” or “a specific configuration is configured for a UE” described in the present disclosure may represent the specific configuration that is, but is not limited to be, configured within a DL RRC message.

In some implementations, “a specific configuration is per cell group configured” or “a specific configuration is configured for a cell group” described in the present disclosure may represent the specific configuration that is, but is not limited to be, configured within a cell group configuration (e.g., the CellGroupConfig, MAC-CellGroupConfig, or PhysicalCellGroupConfig IE).

In some implementations, “a specific configuration is per serving cell configured” or “a specific configuration is configured for a serving cell” described in the present disclosure may represent the specific configuration that is, but is not limited to be, configured within a serving cell configuration (e.g., the ServingCellConfigCommon, ServingCellConfig, PUSCH-ServingCellConfig, or PDSCH-ServingCellConfig IE).

In some implementations, “a specific configuration is per UL BWP or per BWP configured” or “a specific configuration is configured for a UL BWP or for a BWP” described in the present disclosure may represent the specific configuration that is, but is not limited to be, configured within one of the followings IEs: the BWP-Uplink, BWP-UplinkDedicated, BWP-UplinkCommon, PUSCH-ConfigCommon, and PUSCH-Config.

In some implementations, “a specific configuration is per DL BWP or per BWP configured” or “a specific configuration is configured for a DL BWP or for a BWP” described in the present disclosure may represent the specific configuration that is, but is not limited to be, configured within one of the followings IEs: the BWP-Downlink, BWP-DownlinkDedicated, BWP-DownlinkCommon, PDSCH-ConfigCommon, and PDSCH-Config IE.

In some implementations, A PDSCH/PDSCH/PUSCH transmission may span multiple symbols in the time domain. A time duration of a PDSCH/PDSCH/PUSCH (transmission) may imply a time interval that starts from the beginning of the first symbol of the PDSCH/PDSCH/PUSCH (transmission) and ends at the end of the last symbol of the PDSCH/PDSCH/PUSCH (transmission).

The term “A and/or B” within the present disclosure means “A”, “B”, or “A and B”. The term “A and/or B and/or C” within the present disclosure means “A”, “B”, “C”, “A and B”, “A and C”, “B and C”, or “A and B and C”. The term “A/B” within the present disclosure means “A” or “B”.

The term “(specific) PHY layer signaling” may refer to a specific format of the DCI, a specific field of the DCI, a specific field of the DCI with the field being set to a specific value, and/or the DCI with CRC bits scrambled with a specific RNTI.

In the present disclosure, “a MAC timer” may include, but is not limited to, a timer configured by a base station via RRC signaling. The UE may be configured with an initial value of the timer and the unit of the value may include, but is not limited to, frame/sub-frame/milli second/sub-milli second/slot/symbol. The timer may be started and/or restarted by the UE (e.g., by the MAC entity of the UE). The timer may be started and/or restarted by the UE (e.g., by the MAC entity of the UE) when a specific condition is satisfied.

Examples of some selected terms are provided as follows.

Antenna Panel: a conceptual term for a UE antenna implementation. It may be assumed that a panel is an operational unit for controlling a transmitting spatial filter (beam). A panel may typically include multiple antenna elements. In one implementation, a beam may be formed by a panel, and in order to form two beams simultaneously, two panels may be needed. Such simultaneous beamforming from multiple panels may be subject to UE capability. A similar definition for “panel” may be applicable by applying spatial receiving filtering characteristics. The UE panel information may be derived from the TCI state/UL beam indication information or from the network signaling.

Beam: A beam may refer to a spatial (domain) filtering. In one example, the spatial filtering may be applied in the analog domain by adjusting a phase and/or an amplitude of a signal before being transmitted by a corresponding antenna element. In another example, the spatial filtering may be applied in the digital domain by the Multi-Input Multi-Output (MIMO) technique in the wireless communication system. For example, “a UE made a PUSCH transmission by using a specific beam” may imply that the UE made the PUSCH transmission by using the specific spatial/digital domain filter. The “beam” may also be, but is not limited to be, represented as an antenna, an antenna port, an antenna element, a group of antennas, a group of antenna ports, or a group of antenna elements. The beam may also be formed by a certain reference signal resource. In short, the beam may be equivalent to a spatial domain filter through which the EM wave is radiated. Beam information may include details about the selected or utilized beam or spatial filter. In some implementations, the individual beams (e.g., spatial filters) may be used to transmit individual reference signals. Consequently, a beam or beam information may be represented by one or more reference signal resource indices.

DCI: DCI may include downlink control information, and there may be various DCI formats used in a PDCCH. The DCI format may be a predefined format in which the downlink control information may be packed/formed and transmitted in a PDCCH.

TCI state: A TCI state may include parameters for configuring a QCL relationship between one or more DL reference signals and a target reference signal set. For example, a target reference signal set may include the DMRS ports of a PDSCH, a PDCCH, a PUCCH, or a PUSCH. The reference signals may include UL or DL reference signals. In NR Rel-15/16, the TCI state may be used for a DL QCL indication, whereas the spatial relation information may be used for providing the UL spatial transmission filter information for the UL signal(s) or channel(s). A TCI state may include the information similar to the spatial relation information, which may be used for UL transmission. In other words, from the UL perspective, a TCI state may provide the UL beam information that may indicate the relationship between a UL transmission and the DL or UL reference signals (e.g., the CSI-RS, the SSB, the SRS, and the PTRS).

HARQ: A functionality that ensures the delivery between peer entities at Layer 1 (e.g., Physical Layer). A single HARQ process supports one Transport Block (TB) when the physical layer is not configured for the downlink/uplink spatial multiplexing, and when the physical layer is configured for downlink/uplink spatial multiplexing, a single HARQ process may support one or more TBs. There is one HARQ entity per serving cell. Each HARQ entity may support a parallel (number of) DL and UL HARQ process.

It should be noted that “A Quasi Co-Located (QCLed) with B” may mean that the “A” shares the same channel characteristic(s)/QCL assumption with the “B”. Types of the channel characteristic(s)/QCL assumption may include:
‘typeA’: {Doppler shift, Doppler spread, average delay, delay spread};
‘typeB’: {Doppler shift, Doppler spread};
‘typeC’: {Doppler shift, average delay}; and/or
‘typeD’: {Spatial Rx parameter}.

In some implementations, the source cell/gNB may configure one or more candidate target cell(s) for a UE to perform a Layer 1/Layer 2 Triggered Mobility (LTM) procedure. Each candidate target cell may be identified by a logical index. For example, the UE may be configured with N candidate target cell configurations from the source cell during the RRC pre-configuration step, where Nis the number of candidate target cells configured for the UE (N being a positive integer). Additionally, N may be provided/configured to the UE via RRC signaling or may be determined by the UE's capability. For example, the UE may report the maximum value of N via an RRC message before being configured with the LTM candidate target cell configurations. Each candidate target cell configuration may be identified by a logical index (e.g., from 1 to N), where the logical index may represent an LTM candidate cell index.

In some implementations, a candidate target cell configured with an early UL synchronization configuration may be the candidate target cell associated with a candidate target cell configuration (e.g., an RRC-configured IE LTM-Candidate) that includes an early UL synchronization configuration (e.g., an RRC-configured IE ltm-EarlyUL-SyncConfig).

It should be noted that the term “LTM-based PDCCH ordered RACH” may refer to a random access (RA) procedure initiated by a PDCCH order, where the procedure does not include the step of receiving a random access response (RAR). For example, if a UE is instructed to perform a PDCCH ordered RACH without a RAR reception, the UE may only transmit the preamble to the candidate target cell indicated in the PDCCH and may not expect to monitor the PDCCH for the RAR scheduling. In other words, the UE may skip the other conventional RA procedure steps following the PRACH (e.g., preamble) transmission.

In some implementations, the UE may transmit the first UL data to the target cell after successfully receiving the cell switch command (e.g., after transmitting a PUCCH/PUSCH with HARQ-ACK information corresponding to the PDSCH carrying the cell switch command to the gNB/NW/source cell, where the HARQ-ACK information may be an ACK or a HARQ-ACK information bit “1”). The transmission of the first UL data may be either a dynamic-grant, or a configured-grant, based PUSCH transmission. Additionally, the first UL data may represent the first transport block (TB) transmitted to the target cell after successfully receiving the cell switch command (e.g., after transmitting a PUCCH/PUSCH with HARQ-ACK information corresponding to the PDSCH carrying the cell switch command to the gNB/NW/source cell, where the HARQ-ACK information may be an ACK or a HARQ-ACK information bit “1”).

It should be noted that the source cell/gNB may transmit the information corresponding to the target cell via a MAC CE to the UE. Furthermore, the MAC CE may be used to indicate that the UE should switch from the source cell to the candidate target cell specified in the MAC CE. The MAC CE used for instructing the UE to perform the cell switching may be referred to as an LTM cell switch MAC CE, an LTM cell switch command, a cell switch MAC CE, or a cell switch command in the present disclosure.

In some implementations, a RACH procedure (e.g., an RA procedure) may be initiated by the LTM cell switch MAC CE in a case that one or more of the following are satisfied:
(1) the timing advanced (TA) field included in the LTM cell switch MAC CE indicates an invalid value (e.g., FFF); and/or
(2) the TA field included in the LTM cell switch MAC CE indicates an invalid value (e.g., FFF), and the contention-free random access-related (CFRA-related) (or RACH configuration-related) field(s) are present in the LTM cell switch MAC CE.

During an LTM procedure, two types of TA acquisition schemes (e.g., RACH-based and RACH-less schemes) may be applied by a UE to acquire the TA value(s) corresponding to the candidate target cell(s) or target cell(s).

In some implementations, the UE may be instructed to perform the PDCCH-ordered RA procedure(s) for one or more candidate target cells with an early UL synchronization configuration. In some implementations, if the RRC configuration of a candidate target cell includes an early UL synchronization configuration, the UE may receive a PDCCH (e.g., DCI format 1_0 with CRC scrambled by C-RNTI and the DCI field “Frequency domain resource assignment” set to all ones) to perform the LTM-based PDCCH ordered RACH procedure with that candidate target cell. The early UL synchronization configuration may include one or more of RACH occasion(s) information and power ramping step information.

The RACH occasion(s) information may include the frequency and/or time for the RACH occasion(s). For example, the RACH occasion(s) information may indicate the physical time/frequency resources for each RACH occasion configured to the UE.

The power ramping step information may provide the step size for power ramping during a PRACH re-transmission.

In some implementations, after receiving the cell switch command MAC CE, a UE may transmit UL data (e.g., RRCReconfigurationComplete message, search report (SR), and/or other UL data) to the target cell if the UE has acquired the TA of the target cell via RACH-less schemes. The UE may transmit the data on pre-allocated UL resource(s) (e.g., pre-configured UL grant(s) or UL grant(s) pre-configured in the LTM candidate target cell configuration corresponding to the target cell) without sending scheduling requests to the target/source cell for the UL resource(s). The data may include at least the RRCReconfigurationComplete message to confirm the successful completion of the LTM procedure.

In some implementations, a UE may be configured, via RRC signaling, with one or more pre-allocated UL resources by the source cell/gNB, target cell/gNB, or candidate target cell/gNB for transmitting data after receiving the cell switch command. The pre-allocated UL resource(s) may be associated with one or more synchronization signal blocks (SSBs) or transmission configuration indicator (TCI) states corresponding to one or more candidate target cells. The TCI states may include DL TCI states, UL TCI states, or joint TCI states. In some implementations, the source cell/gNB may receive information on the pre-allocated UL resource(s) and associated SSBs/TCI states from the target cell/gNB, or candidate target cells/gNBs, via the XnAP or F1AP interfaces in XnAP or F1AP messages, depending on whether the source cell/gNB, the target cell/gNB, or the candidate target cells/gNBs are inter-DU or intra-DU. The source cell/gNB may then transmit the RRCReconfiguration message, including the information of the pre-allocated UL resource(s) and the associated SSBs/TCI states, to the UE for configuration.

In some implementations, a UE may be configured with one or more CG configurations (or a list of CG configurations) for performing an LTM procedure, where the one or more CG configurations (or the list of CG configurations) may be transmitted by the source cell/gNB via RRC signaling (e.g., in the RRCReconfiguration message). In addition, the one or more CG configurations (or the list of CG configurations) may be associated with (or included in) a candidate target cell configuration (e.g., an IE LTM-Candidate). In other words, the candidate target cell-specific CG configuration(s) (or CG configuration list) may be configured to a UE by the source cell/gNB via RRC signaling. For example, a UE may receive one or more candidate target cell configurations (e.g., an IE LIM-Candidate) transmitted by the source cell/gNB via RRC signaling. Each candidate target cell configuration (e.g., an IE LTM-Candidate) may include a logical index associated with a candidate target cell (e.g., an RRC field ltm-CandidateId) and with the one or more CG configurations (or a list of CG configurations).

In some implementations, a UE may be configured with one or more CG configurations (or a list of CG configurations) for performing an LTM procedure, where the one or more CG configurations (or a list of CG configurations) may be transmitted by the source cell/gNB via RRC signaling. In addition, the one or more CG configurations (or a list of CG configurations) may be associated with all the candidate target cell configurations. In other words, common CG configuration(s) (or CG configuration list) may be configured to a UE by the source cell/gNB via RRC signaling.

In some implementations, a UE may receive one or more CG configurations (or a list of CG configurations) transmitted by the source cell/gNB via RRC signaling. Each CG configuration list may include one or more CG configurations, and each CG configuration may be associated with a logical index associated with a candidate target cell (e.g., an RRC field ltm-CandidateId). In some implementations, a candidate cell index may be associated with a CG configuration index. In some implementations, each logical index may correspond to a candidate cell index with an order from the lowest index to the highest index. For example, if a candidate cell #1, a candidate cell #2, and a candidate cell #3 are configured to a UE, the logical index #0 may correspond to the candidate cell index #1, the logical index #1 may correspond to the candidate cell index #2, and the logical index #2 may correspond to the candidate cell index #3.

In some implementations, a UE may receive one or more CG configurations (or a list of CG configurations) transmitted by the source cell/gNB via RRC signaling. Each CG configuration list may include one or more CG configurations, and each CG configuration may be shared by all the candidate target cells.

In some implementations, a UE may receive one or more CG configurations (or a list of CG configurations) transmitted by the source cell/gNB via RRC signaling, where each CG configuration may be used for a PUSCH transmission for the LTM. Each CG configuration may include multiple fields corresponding to transmitted parameters of the PUSCH transmission. However, if the CG configuration is configured for the PUSCH transmission for the LTM, at least one of the following fields corresponding to the transmitted parameters of the PUSCH transmission may not be configured to the UE or may be ignored by the UE: antennaPort, pathlossReferenceIndex, precodingAndNumberOfLayers, srs-ResourceIndicator, mcs-Table, and mcs-Table TransformPrecoder.

In some implementations, the antennaPort field may be used to indicate one or more antenna ports used for the PUSCH transmission. If the CG configuration is applied for the LTM, the UE may ignore the antennaPort field included in the CG configuration.

In some implementations, the pathlossReferenceIndex field may be used to indicate a reference signal index which is used as a PUSCH pathloss reference. If the CG configuration is applied for the LTM, the UE may not use the pathlossReferenceIndex field. If the CG configuration is applied for the LTM, the UE may apply the pathloss reference signal associated with the TCI state indicated in the cell switch command for the corresponding PUSCH transmission for the LTM.

In some implementations, the precodingAndNumberOfLayers field may be used to indicate precoding and number of layers for the PUSCH transmission. If the CG configuration is applied for the LTM, the network may set the precodingAndNumberOfLayers field to a specific value (e.g., 1).

In some implementations, the srs-ResourceIndicator may be used to indicate an SRS resource to be used for the PUSCH transmission. If the CG configuration is applied for the LTM, the network may not configure the srs-ResourceIndicator field in the CG configuration.

In some implementations, the mcs-Table may be used to indicate an MCS table that the UE may use for PUSCH without transform precoding. If the CG configuration is applied for the LTM, the network may not configure the mcs-Table field in the CG configuration.

In some implementations, the mcs-Table TransformPrecoder may be used to indicate an MCS table that the UE may use for PUSCH with transform precoding. If the CG configuration is applied for the LTM, the network may not configure the mcs-Table TransformPrecoder field in the CG configuration.

In some implementations, a UE may receive one or more CG configurations (or a list of CG configurations) transmitted by the source cell/gNB via RRC signaling, where each CG configuration may be used for a PUSCH transmission for the LTM. Each CG configuration may include at least one of the following fields for PUSCH transmission for the LTM: ltm-SSB-Subset, ltm-DMRS-ports, ltm-NrofDMRS-Sequence, ltm-P0-PUSCH, and ltm-Alpha.

In some implementations, the ltm-SSB-Subset field may be used to indicate an SSB subset for an SSB to CG occasion (e.g., PUSCH) mapping. If the ltm-SSB-Subset field is absent, the UE may assume that the SSB subset includes all actually transmitted SSBs corresponding to a candidate target cell or all candidate target cells.

In some implementations, the ltm-DMRS-ports field may be used to indicate a set of DMRS ports for an SSB to CG occasion (e.g., PUSCH) mapping.

In some implementations, the ltm-NrofDMRS-Sequence field may be used to indicate a number of DMRS sequence for an SSB to CG occasion (e.g., PUSCH) mapping.

In some implementations, the ltm-P0-PUSCH field may be used to indicate a PO value for PUSCH transmission for the LTM in steps of 1 dB. When the ltm-P0-PUSCH field is configured, the UE may ignore the p0-PUSCH-Alpha field included in the CG configuration.

In some implementations, the ltm-Alpha field may be used to indicate an alpha value for PUSCH transmission. The ltm-Alpha field reads “alpha0” may indicate that value 0 is used for calculating a transmission power of PUSCH, the ltm-Alpha field reads “alpha4” may indicate that value 4 is used for calculating a transmission power of PUSCH, and so on. When the ltm-Alpha field is configured, the UE may ignore the p0-PUSCH-Alpha field included in the CG configuration.

In some implementations, a UE may be configured with one or more lists of TCI state(s) (e.g., including a UL TCI state list and/or a DLorJointTCI state list) for performing an LTM procedure, where the one or more lists of TCI state(s) (e.g., including a UL TCI state list and/or a DLorJointTCI state list) may be transmitted by the source cell/gNB via RRC signaling. In addition, the one or more lists of TCI state(s) may be associated with a candidate target cell configuration (e.g., an IE LTM-Candidate). In other words, candidate target cell-specific TCI state list(s) may be configured to a UE by the source cell/gNB via RRC signaling. For example, a UE may receive one or more candidate target cell configurations (e.g., an IE LTM-Candidate) transmitted by the source cell/gNB via RRC signaling. Each candidate target cell configuration (e.g., an IE LTM-Candidate) may include a logical index associated with a candidate target cell (e.g., an RRC field ltm-CandidateId) and each candidate target cell configuration (e.g., an IE LTM-Candidate) may include one or more lists of TCI state(s) (e.g., UL TCI state list and/or DLorJointTCI state list).

In some implementations, each TCI state (e.g., a UL TCI state and/or a DLorJointTCI state) included in a TCI state list may include at least one of the following fields: a logical index of candidate target cell field, a UL TCI state index field, a DL TCI state index field, a joint TCI state index field, a source RS field (e.g., the referenceSignal), and a CG configuration index field (e.g., the configuredGrantConfigIndex and/or the configuredGrantConfigIndexMAC).

In some implementations, the logical index of candidate target cell field may be an index used to indicate the candidate target cell with which the TCI state (e.g., a DL TCI state, a UL TCI state and/or a joint TCI state) is associated.

In some implementations, the UL TCI state index may be an index used to identify the UL TCI state(s) configured within a candidate target cell.

In some implementations, the DL TCI state index may be an index used to identify the DL TCI state(s) configured within a candidate target cell.

In some implementations, the joint TCI state index may be an index used to identify the joint TCI state(s) configured within a candidate target cell.

In some implementations, the source RS field may be used to provide the quasi-collocation information for DM-RS of PDSCH and/or DM-RS of PDCCH in a candidate target cell/target cell, used for CSI-RS, used to provide a reference for determining UL TX spatial filter for dynamic-grant and configured-grant based PUSCH and PUCCH resource in a candidate target cell/target cell, and/or used for SRS. In some implementations, the source RS may be SSB, CSI-RS and/or TRS.

In some implementations, the CG configuration index field may be used to indicate the CG occasion (or CG configuration) with which the TCI state (e.g., a DL TCI state, a UL TCI state and/or a joint TCI state) is associated.

In some implementations, a TCI state configuration (e.g., a DL TCI state configuration, a UL TCI state configuration and/or a joint TCI state configuration) may include the CG configuration index field to indicate the CG occasion (or CG configuration) with which the TCI state (e.g., a DL TCI state, a UL TCI state and/or a joint TCI state) is associated.

In some implementations, a UE may be configured with one or more lists of TCI state(s) (e.g., including a UL TCI state list and/or a DLorJointTCI state list) for performing an LTM procedure, where the one or more lists of TCI state(s) (e.g., including a UL TCI state list and/or a DLorJointTCI state list) may be transmitted by the source cell/gNB via RRC signaling. In addition, the one or more lists of TCI state(s) may be associated with all candidate target cell configurations. In other words, common TCI state list(s) may be configured to a UE by the source cell/gNB via RRC signaling. For example, a UE may receive one or more list(s) of TCI states (e.g., including a UL TCI state list and/or a DLorJointTCI state list) transmitted by the source cell/gNB via RRC signaling. Each TCI state list may include one or more TCI state configurations, and each TCI state configuration may be associated with a logical index associated with a candidate target cell (e.g., an RRC field ltm-CandidateId).

In some implementations, each TCI state (e.g., a UL TCI state and/or a DLorJointTCI state) included in the TCI state list may include at least one of the following fields as described above: the logical index of candidate target cell field, the UL TCI state index field, the DL TCI state index field, the joint TCI state index field, the source RS field (e.g., the referenceSignal), and the CG configuration index field (e.g., the configuredGrantConfigIndex and/or the configuredGrantConfigIndexMAC).

In some implementations, a UE may be configured with the one or more lists of TCI state(s) and one or more CG configurations corresponding to a candidate target cell. For example, a UE may receive one or more candidate target cell configuration(s) (e.g., an IE LIM-Candidate) transmitted by the source cell/gNB via RRC signaling. Each candidate target cell configuration (e.g., an IE LIM-Candidate) may include a logical index associated with a candidate target cell (e.g., an RRC field ltm-CandidateId). Each of the one or more lists of TCI state(s) (e.g., including a UL TCI state list and/or a DLorJointTCI state list) and each of the one or more CG configurations may be associated with a candidate target cell configuration (e.g., an IE LTM-Candidate).

In some implementations, if a candidate target cell is associated with N TCI states (e.g., DL TCI states, UL TCI states and/or joint TCI states) (N being a positive integer), the N TCI state indexes (e.g., the indexes of the N TCI states) may be mapped to valid PUSCH occasions (or CG occasions) and associated DM-RS resources:
1) firstly, in an increasing order of the DM-RS resource indexes within the PUSCH occasion (or CG occasion), where a DMRS resource index is determined firstly in an ascending order of a DM-RS port index and then determined in an ascending order of a DM-RS sequence index; and
2) secondly, in an increasing order of the PUSCH configuration (or CG configuration) period indexes.

In some implementations, if a candidate target cell is associated with N TCI states (e.g., DL TCI states, UL TCI states and/or joint TCI states) (N being a positive integer), the N TCI state indexes may be mapped to valid PUSCH (or CG) configurations (e.g., the RRC configurations of valid PUSCH occasions). In some implementations, each PUSCH (or CG) configuration may include the CG configuration index field that is used to identify the PUSCH (or CG) configuration. Each candidate target cell configuration may include one RRC field (e.g., TCI-perCG) to indicate the number of TCI states per PUSCH (or CG) configuration. In some implementations, the RRC field (e.g., TCI-perCG) may be given as:
TCI-perCG ENUMERATED {oneEighth, oneFourth, oneHalf, one, two, four, eight};
TCI-perCG ENUMERATED {oneFourth, oneHalf, one, two, four, eight}; or
TCI-perCG ENUMERATED {oneHalf, one, two, four}, etc.

In some implementations, the value “oneEighth” may correspond to one TCI state associated with eight PUSCH (or CG) configurations, the value “oneFourth” may correspond to one TCI state associated with four PUSCH (or CG) configurations, and so on.

In some implementations, a UE may be provided with L TCI state indexes associated with one valid PUSCH (or CG) configuration (L being a positive integer), or with one valid CG configuration index, by the RRC field (e.g., TCI-perCG) included in the candidate target cell configuration. If L<1 (e.g., TCI-perCG is set to oneEighth, oneFourth and/or oneHalf), one TCI state index may be mapped to 1/L consecutive valid PUSCH (or CG) configurations, or 1/L valid CG configuration indexes. If L≥1 (e.g., TCI-perCG is set to one, two, four and/or eight), all consecutive L TCI state index may be mapped to one valid PUSCH (or CG) configuration, or one valid CG configuration index.

In some implementations, TCI state indexes provided by an RRC field included in the TCI state configuration included in the list of TCI states included in the candidate target cell configuration may be mapped to valid CG configuration indexes provided by an RRC field included in the PUSCH (or CG) configuration(s) (included in the list of PUSCH (or CG) configurations) included in the candidate target cell configuration in an increasing order of the valid CG configuration indexes.

In some implementations, the number N (e.g., N being a positive integer) may be determined by the number of TCI states configured to a candidate target cell or determined by a value/parameter indicated via RRC signaling.

In some implementations, a UE may receive one or more candidate target cell configurations (e.g., an IE LTM-Candidate) transmitted by the source cell/gNB via RRC signaling. Each candidate target cell configuration (e.g., an IE LTM-Candidate) may include a logical index associated with a candidate target cell (e.g., an RRC field ltm-CandidateId) and the one or more (lists of) TCI states (e.g., UL TCI state list and/or DLorJointTCI state list). In addition, the UE may receive the one or more CG configurations configured for the PUSCH transmission for all candidate target cells by the source cell/gNB via RRC signaling. In other words, the one or more CG configurations (included in the RRCReconfiguration message) may be shared by all candidate target cells.

In some implementations, if a candidate target cell is associated with N TCI states (e.g., DL TCI states, UL TCI states and/or joint TCI states) (N being a positive integer), the N TCI state indexes may be mapped to valid PUSCH occasions (or CG occasions) and associated DM-RS resources:
1) firstly, in an increasing order of the DM-RS resource indexes within a PUSCH occasion (or CG occasion), where a DMRS resource index is determined firstly in an ascending order of a DM-RS port index and then determined in an ascending order of a DM-RS sequence index; and
2) secondly, in an increasing order of the PUSCH configuration (or CG configuration) period indexes.

In some implementations, if all candidate target cells are associated with M TCI states (e.g., DL TCI states, UL TCI states and/or joint TCI states) (M being a positive integer), the M TCI state indexes may be mapped to valid PUSCH occasions (or CG occasions) and associated DM-RS resources:
1) firstly, in an increasing order of the DM-RS resource indexes within a PUSCH occasion (or CG occasion), where a DMRS resource index is determined firstly in an ascending order of a DM-RS port index and then determined in an ascending order of a DM-RS sequence index; and
2) secondly, in an increasing order of the PUSCH configuration (or CG configuration) period indexes.

In some implementations, if all candidate target cells are associated with M TCI states (e.g., DL TCI states, UL TCI states and/or joint TCI states) (M being a positive integer), the MTCI state indexes may be mapped to valid PUSCH (or CG) configurations (e.g., the RRC configurations of valid PUSCH occasions). In some implementations, each PUSCH (or CG) configuration may include the CG configuration index field that is used to identify the PUSCH (or CG) configuration. The RRCReconfiguration message may include an RRC field (e.g., TCI-perCG) to indicate the number of TCI states per PUSCH (or CG) configuration. In some implementations, the RRC field (e.g., TCI-perCG) may be given as:
TCI-perCG ENUMERATED {oneEighth, oneFourth, oneHalf, one, two, four, eight};
TCI-perCG ENUMERATED {oneFourth, oneHalf, one, two, four, eight}; or
TCI-perCG ENUMERATED {oneHalf, one, two, four}, etc.

In some implementations, the value “oneEighth” may correspond to one TCI state associated with eight PUSCH (or CG) configurations, the value “oneFourth” may correspond to one TCI state associated with four PUSCH (or CG) configurations, and so on.

In some implementations, a UE may be provided with L TCI state indexes associated with one valid PUSCH (or CG) configuration (or one valid CG configuration index) by the RRC field (e.g., TCI-perCG) included in the candidate target cell configuration (L being a positive integer). If L<1 (e.g., TCI-perCG is set to oneEighth, oneFourth and/or oneHalf), one TCI state index may be mapped to 1/L consecutive valid PUSCH (or CG) configurations, or 1/L valid CG configuration indexes. If L≥1 (e.g., TCI-perCG is set to one, two, four and/or eight), all consecutive L TCI state indexes may be mapped to one valid PUSCH (or CG) configuration, or one valid CG configuration index.

In some implementations, the TCI state indexes provided by an RRC field included in the TCI state configuration included in the list of TCI states included in the RRCReconfiguration message, or the TCI state indexes provided by an RRC field included in the TCI state configuration included in the list of TCI states included in the candidate target cell configuration, may be mapped to valid CG configuration indexes provided by an RRC field included in the PUSCH (or CG) configuration(s) (included in the list of PUSCH (or CG) configurations) included in the RRCReconfiguration message in an increasing order of valid CG configuration indexes.

In some implementations, the number M (e.g., M being a positive integer) may be determined by the number of TCI states (e.g., DL TCI states, UL TCI states and/or joint TCI states) configured to all candidate target cells or determined by multiple values/parameters indicated via RRC signaling (e.g., the summation of the number of TCI states (e.g., DL TCI states, UL TCI states and/or joint TCI states) configured to each candidate target cell), where each value/parameter (e.g., the number of TCI states (e.g., DL TCI states, UL TCI states and/or joint TCI states) configured to each candidate target cell) may be associated with a candidate target cell.

In some implementations, a UE may be configured with one or more SSB configurations (or a list of SSB configurations) for performing an LTM procedure, where the one or more SSB configurations (or a list of SSB configurations) may be transmitted by the source cell/gNB via RRC signaling. In addition, the one or more SSB configurations (or a list of SSB configurations) may be associated with a candidate target cell configuration (e.g., an IE LTM-Candidate). In other words, the candidate target cell-specific SSB configuration(s) (or SSB configuration list) may be configured to a UE by the source cell/gNB via RRC signaling. For example, a UE may receive one or more candidate target cell configurations (e.g., an IE LTM-Candidate) transmitted by the source cell/gNB via RRC signaling. Each candidate target cell configuration (e.g., an IE LTM-Candidate) may include a logical index associated with a candidate target cell (e.g., an RRC field ltm-CandidateId) and each candidate target cell configuration (e.g., an IE LTM-Candidate) may include one or more SSB configurations (or a list of SSB configurations).

In some implementations, each SSB configuration (e.g., included in the SSB configuration list) may include at least one of the following fields: a logical index of candidate target cell field, a periodicity field, ssb-PositionInBurst, ss-PBCH-BlockPower, and a CG configuration index field.

In some implementations, the logical index of candidate target cell field may be an index used to indicate the candidate target cell with which the SSB configuration is associated.

In some implementations, the SSB configuration configured for the LTM may include a periodicity field that is used to indicate the periodicity of the SSB(s). In some implementations, periodicity may be given in number of subframes, frames, slots and/or ms.

In some implementations, the SSB configuration configured for the LTM may include the ssb-PositionInBurst field that is used to indicate the time domain positions of the transmitted SSB(s) within a half frame that includes multiple SSBs.

In some implementations, the SSB configuration configured for the LTM may include a ss-PBCH-BlockPower field to indicate an average energy per resource element (EPRE) in dBm for the resource elements carrying secondary synchronization signals that the network used for SSB transmission.

In some implementations, the CG configuration index may be used to indicate the CG occasion (or CG configuration) with which the SSB is associated.

In some implementations, a SSB configuration may include a CG configuration index field to indicate the CG occasion (or CG configuration) with which SSB is associated.

In some implementations, a UE may be configured with one or more SSB configurations (or a list of SSB configurations) for performing an LTM procedure, where the one or more SSB configurations (or a list of SSB configurations) may be transmitted by the source cell/gNB via RRC signaling. In addition, the one or more SSB configurations (or a list of SSB configurations) may be associated with all candidate target cell configurations. For example, each SSB configuration (or SSB configuration included in a SSB configuration list) may be associated with a logical index associated with a candidate target cell (e.g., ltm-CandidateId). In other words, common SSB configurations (or a SSB configuration list) may be configured to a UE by the source cell/gNB via RRC signaling. For example, a UE may receive one or more SSB configurations (or a list of SSB configurations) transmitted by the source cell/gNB via RRC signaling. Each SSB configuration list may include one or more SSB configuration(s). Each SSB configuration may be associated with a logical index associated with a candidate target cell (e.g., ltm-CandidateId).

In some implementations, each SSB configuration (included in the SSB configuration list) may include at least one of the following fields: the logical index of candidate target cell field, the periodicity field, ssb-PositionInBurst, ss-PBCH-BlockPower, and the CG configuration index field, as described above.

In some implementations, a UE may be configured with the one or more SSB configurations (or a list of SSB configurations) and one or more CG configurations corresponding to a candidate target cell. For example, a UE may receive one or more candidate target cell configurations (e.g., an IE LTM-Candidate) transmitted by the source cell/gNB via RRC signaling. Each candidate target cell configuration (e.g., an IE LIM-Candidate) may include a logical index associated with a candidate target cell (e.g., an RRC field ltm-CandidateId). Each of the one or more SSB configurations (or a list of SSB configurations) and each of the one or more CG configurations may be associated with a candidate target cell configuration (e.g., an IE LIM-Candidate).

In some implementations, if a candidate target cell is associated with N SSB configurations (N being a positive integer), the N SSB configurations may be mapped to valid PUSCH occasion (or CG occasion) and associated DM-RS resources:
1) firstly, in an increasing order of the DM-RS resource indexes within a PUSCH occasion (or CG occasion), where a DMRS resource index is determined first in an ascending order of a DM-RS port index and then determined in an ascending order of a DM-RS sequence index; and
2) secondly, in an increasing order of the PUSCH configuration (or CG configuration) period indexes.

In some implementations, if a candidate target cell is associated with N SSB configurations (N being a positive integer), the N SSB configuration indexes may be mapped to valid PUSCH (or CG) configurations (e.g., the RRC configurations of valid PUSCH occasions). In some implementations, each PUSCH (or CG) configuration may include the CG configuration index field that is used to identify the PUSCH (or CG) configuration. Each candidate target cell configuration may include an RRC field (e.g., SSB-perCG) to indicate the number of SSB configurations per PUSCH (or CG) configuration. In some implementations, the RRC field (e.g., SSB-perCG) may be given as:
SSB-perCG ENUMERATED {oneEighth, oneFourth, oneHalf, one, two, four, eight};
SSB-perCG ENUMERATED {oneFourth, oneHalf, one, two, four, eight}; or
SSB-perCG ENUMERATED {oneHalf, one, two, four}, etc.

In some implementations, the value “oneEighth” may correspond to one SSB configuration associated with eight PUSCH (or CG) configurations, the value “oneFourth” may correspond to one SSB configuration associated with four PUSCH (or CG) configurations, and so on.

In some implementations, a UE may be provided with L SSB configuration indexes associated with one valid PUSCH (or CG) configuration or with one valid CG configuration index by the RRC field (e.g., SSB-perCG) included in the candidate target cell configuration (L being a positive integer). If L<1 (e.g., SSB-perCG is set to oneEighth, oneFourth and/or oneHalf), one SSB configuration index may be mapped to 1/L consecutive valid PUSCH (or CG) configurations, or 1/L valid CG configuration indexes. If L≥1 (e.g., SSB-perCG is set to one, two, four and/or eight), all consecutive L SSB configuration indexes may be mapped to one valid PUSCH (or CG) configuration or one valid CG configuration index.

In some implementations, the SSB configuration indexes provided by an RRC field included in the SSB configuration included in the list of SSB configurations included in the candidate target cell configuration may be mapped to valid CG configuration indexes provided by an RRC field included in the PUSCH (or CG) configuration(s) (included in the list of PUSCH (or CG) configurations) included in the candidate target cell configuration in an increasing order of valid CG configuration indexes.

In some implementations, the number N (e.g., N being a positive integer) may be determined by the number of SSBs configured to a candidate target cell or determined by a value/parameter indicated via RRC signaling.

In some implementations, a UE may receive one or more candidate target cell configurations (e.g., an IE LTM-Candidate) transmitted by the source cell/gNB via RRC signaling. Each candidate target cell configuration (e.g., an IE LTM-Candidate) may include a logical index associated with a candidate target cell (e.g., an RRC field ltm-CandidateId) and each candidate target cell configuration (e.g., an IE LIM-Candidate) may include one or more SSB configurations (or a list of SSB configurations). In addition, the UE may receive the one or more CG configurations configured for the PUSCH transmission for all candidate target cells by the source cell/gNB via RRC signaling.

In some implementations, if all candidate target cells are associated with M SSB configurations (M being a positive integer), the M SSB configuration indexes may be mapped to a valid PUSCH occasion (or CG occasion) and the associated DM-RS resources:
1) firstly, in an increasing order of the DM-RS resource indexes within a PUSCH occasion (or CG occasion), where a DMRS resource index is determined first in an ascending order of a DM-RS port index and then determined in an ascending order of a DM-RS sequence index; and
2) secondly, in an increasing order of the PUSCH configuration (or CG configuration) period indexes.

In some implementations, if all candidate target cells are associated with M SSB configurations (M being a positive integer), the M SSB configuration indexes may be mapped to valid PUSCH (or CG) configurations (e.g., the RRC configurations of valid PUSCH occasions). In some implementations, each PUSCH (or CG) configuration may include the CG configuration index field that is used to identify the PUSCH (or CG) configuration. The RRCReconfiguration message may include an RRC field (e.g., SSB-perCG) to indicate the number of SSB configurations per PUSCH (or CG) configuration. In some implementations, the RRC field (e.g., SSB-perCG) may be given as:
SSB-perCG ENUMERATED {oneEighth, oneFourth, oneHalf, one, two, four, eight};
SSB-perCG ENUMERATED {oneFourth, oneHalf, one, two, four, eight}; or
SSB-perCG ENUMERATED {oneHalf, one, two, four}, etc.

In some implementations, the value “oneEighth” may correspond to one SSB configuration associated with eight PUSCH (or CG) configurations, the value “oneFourth” may correspond to one SSB configuration associated with four PUSCH (or CG) configurations, and so on.

In some implementations, a UE may be provided with L SSB configuration indexes associated with one valid PUSCH (or CG) configuration or with one valid CG configuration index by the RRC field (e.g., SSB-perCG) included in the candidate target cell configuration (L being a positive integer). If L<1 (e.g., SSB-perCG is set to oneEighth, oneFourth and/or oneHalf), one SSB configuration index may be mapped to 1/L consecutive valid PUSCH (or CG) configurations, or 1/L valid CG configuration index. If L≥1 (e.g., SSB-perCG is set to one, two, four and/or eight), all consecutive L SSB configuration indexes may be mapped to one valid PUSCH (or CG) configuration or one valid CG configuration index.

In some implementations, the SSB configuration indexes provided by an RRC field included in the SSB configurations included in the list of SSB configurations included in the RRCReconfiguration message (or SSB configuration indexes provided by an RRC field included in the SSB configurations included in the list of SSB configurations included in the candidate target cell configuration) may be mapped to valid CG configuration indexes provided by an RRC field included in the PUSCH (or CG) configuration(s) (included in the list of PUSCH (or CG) configurations) included in the RRCReconfiguration message in an increasing order of valid CG configuration indexes.

In some implementations, the number M (e.g., M being a positive integer) may be determined by the number of SSBs configured to all candidate target cells or determined by multiple values/parameters indicated via RRC signaling, where each value/parameter may be associated with a candidate target cell.

In some implementations, a UE may receive one or more candidate target cell configurations (e.g., an IE LTM-Candidate) transmitted by the source cell/gNB via RRC signaling. Each candidate target cell configuration (e.g., an IE LTM-Candidate) may include a logical index associated with a candidate target cell (e.g., an RRC field ltm-CandidateId) and each candidate target cell configuration (e.g., an IE LIM-Candidate) may include one or more SSB configurations (or a list of SSB configurations). In addition, the UE may receive one or more CG configurations configured for the PUSCH transmission for all candidate target cells and one or more SSB configurations (or a list of SSB configurations) configured for all candidate target cells by the source cell/gNB via RRC signaling.

In some implementations, if a candidate target cell is associated with N SSB configurations (N being a positive integer), the N SSB configurations may be mapped to valid PUSCH occasion (or CG occasion) and associated DM-RS resources:
1) firstly, in an increasing order of the DM-RS resource indexes within a PUSCH occasion (or CG occasion), where a DMRS resource index is determined first in an ascending order of a DM-RS port index and then determined in an ascending order of a DM-RS sequence index; and
2) secondly, in an increasing order of the PUSCH configuration (or CG configuration) period indexes.

In some implementations, if all candidate target cells are associated with K SSB configurations (e.g., a summation of the number of SSB configurations of each candidate target cell is K), the K SSB configuration indexes may be mapped to valid PUSCH occasions (or CG occasions) and associated DM-RS resources:
1) firstly, in an increasing order of the DM-RS resource indexes within a PUSCH occasion (or CG occasion), where a DMRS resource index is determined first in an ascending order of a DM-RS port index and then determined in an ascending order of a DM-RS sequence index; and
2) secondly, in an increasing order of the PUSCH configuration (or CG configuration) period indexes.

In some implementations, the number K may be the summation of SSB configurations of each candidate target cell. For example, if a UE is configured with P candidate target cells identified by candidate cell index #0, candidate cell index #1, . . . , candidate cell index #P-1 and each candidate target cell is configured with N_{candidate cell index} SSB configurations, the number K may be N₀+N₁+ . . . +N_{P-1}. In addition, the order of the K SSB index may be given as:

SSB_{index 0}=SSB_{candidate cell #0,0}, . . . , SSB_{index N}_{₀}₋₁=SSB_{candidate cell #0,N}_{₀}₋₁,

SSB_{index N}_{_{0=SSB}}_{candidate cell #1,0}, . . . , SSB_{index N}_{₀}_{+N}_{₁}₋₁=SSB_{candidate cell #1, N}_{₁}₋₁, . . . , SSB_{index N}_{₀}_{+N}_{₁}_{+ . . . +N}_{_{P-1}}₋₁=SSB_{candidate cell #P-1,N}_{_{P}}₋₁, where N₀+N₁+ . . . ±N_{P-1}=K.

In some implementations, the number K may be determined by the number of SSBs configured to all candidate target cells (e.g., the summation of the number of SSB configurations of each candidate target cell) or determined by a value/parameter indicated via RRC signaling.

In some implementations, a UE may be provided with an RRC parameter (e.g., ltm-SSB-Subset), and a number of SSB indexes (e.g., P) to map to a number of valid PUSCH occasions for PUSCH transmission for the LTM. The P SSB indexes may be mapped to valid PUSCH occasions (or CG occasions) and associated DM-RS resources:
1) firstly, in an increasing order of the DM-RS resource indexes within a PUSCH occasion (or CG occasion), where a DMRS resource index is determined first in an ascending order of a DM-RS port index and then determined in an ascending order of a DM-RS sequence index; and
2) secondly, in an increasing order of the PUSCH configuration (or CG configuration) period indexes.

In some implementations, a UE may be configured with an RRC parameter/field to identify the TA acquisition scheme (e.g., performing an RA procedure before a cell switch command reception, performing an RA procedure after a cell switch command reception and/or a RACH-less scheme for one or more candidate target cells) by the source cell/gNB.

In some implementations, the RRC parameter/field identifying the TA acquisition scheme may be an IE taking ENUMERATED {EARLY_RACH, RACH, RACHLESS}. For example, if the RRC parameter/field identifying the TA acquisition scheme is “EARLY_RACH”, the UE may be configured to perform a PDCCH-ordered RA procedure before receiving a cell switch command for the TA acquisition; if the RRC parameter/field identifying the TA acquisition scheme is “RACH”, the UE may be configured to perform an RA procedure after receiving a cell switch command; if the RRC parameter/field identifying the TA acquisition scheme is “RACHLESS”, the UE may be configure to perform a RACH-less LTM procedure.

In some implementations, for the RACH-less scheme, a UE may be directly indicated with a (specific) TA value (e.g., TA=0) corresponding to the target cell in the TA field included in the cell switch command by the source cell/gNB. In addition, the UE may be indicated that the TA value of the target cell is similar to (or the same as) that of the current serving cell/source cell.

In some implementations, if the TA field included in a cell switch command transmitted by the source cell/gNB indicates a specific value, a UE may apply the TA of the current serving cell/source cell to be the TA of the target cell in a cell switch command transmitted by the source cell/gNB.

In some implementations, a UE may be configured with one or more candidate target cell configuration(s) (e.g., an IE LTM-Candidate) transmitted by the source cell/gNB via RRC signaling. Each candidate target cell configuration may include an RRC field that is used to indicate whether the TA of the candidate target cell is similar to (or the same as) the TA of the current serving cell/source cell. If the candidate target cell configuration of the target cell (e.g., the candidate target cell) indicated in the cell switch command includes the RRC field indicating that the TA of the target cell (e.g., the candidate target cell) is similar to (or the same as) the TA of the current serving cell/source cell, the UE may determine the TA of the target cell (e.g., the candidate target cell indicated in the cell switch MAC CE) is the same as the TA of the current serving cell/source cell. In such a case, the UE may determine that the TA field is absent in the cell switch MAC CE.

In some implementations, if the RRC field used to indicate whether the TA of the candidate target cell is similar to (or the same as) the TA of the current serving cell/source cell is not present (or is absent) in the candidate target cell configuration, the TA of the candidate target cell may not be similar to (or may be different from) the TA of the current serving cell/source cell. If the RRC field used to indicate whether the TA of the candidate target cell is similar to (or the same as) the TA of the current serving cell/source cell is present in the candidate target cell configuration, the TA of the candidate target cell may be similar to (or the same as) the TA of the current serving cell/source cell.

In some implementations, a UE may be configured with an RRC field to indicate whether the TA of the candidate target cell is similar to (or the same as) the TA of the current serving cell/source cell. The RRC field may be given as:
TA-CandidateCell-r18 ENUMERATED {Same as that of source cell, different from that of source cell};
TA-CandidateCell-r18 ENUMERATED {Same as that of source cell}; or
TA-CandidateCell-r18 ENUMERATED {Different from that of source cell}.

In some implementations, the RRC field may be a Boolean indication. When TA-CandidateCell-r18 is “Same as that of source cell” or absent, the TA of the candidate target cell may be similar to (or the same as) the TA of the current serving cell/source cell. When TA-CandidateCell-r18 is “Different from that of source cell” or absent, the TA of the candidate target cell may not be similar to (or may be different from) the TA of the current serving cell/source cell.

In some implementations, for a RACH based scheme applied in the LTM procedure, the UE may be instructed to perform an LTM-based PDCCH-ordered RA procedure for acquiring the TA of a candidate target cell that is configured with an early UL synchronization configuration. After the UE transmits a preamble toward the candidate target cell (e.g., candidate target cell associated with an RRC-configured parameter ltm-CandidateID=1) with an early UL synchronization configuration, the TA value of the candidate target cell (e.g., candidate target cell associated with an RRC-configured parameter ltm-CandidateID=1) may be acquired by the UE in the cell switch MAC CE if the candidate target cell (e.g., candidate target cell associated with an RRC-configured parameter ltm-CandidateID=1) is the target cell indicated to the UE by the source cell.

In some implementations, if the TA field indicates that no valid timing adjustment is available for the target cell (e.g., the value of the TA field is set to FFF), the UE may perform an RA procedure (e.g., perform RACH) according to the RACH configuration indicated in the cell switch command.

In some implementations, the UE may determine the spatial filter used for the PRACH transmission (initiated by the cell switch command) based on the TCI state indicated in the cell switch command. In some implementations, the UE may determine the spatial filter used for the PRACH transmission according to the source RS (or reference Signal) associated with the TCI state indicated in the cell switch command. In some implementations, the source RS (or referenceSignal) may be an SSB, a CSI-RS and/or a TRS corresponding to the target cell (e.g., the candidate target cell indicated in the cell switch command).

In some implementations, the UE may determine the spatial filter used for the PRACH transmission (initiated by the cell switch command) based on the SSB indicated in the cell switch command. In some implementations, the UE may determine the spatial filter used for the PRACH transmission according to the SSB indicated in the cell switch command.

In some implementations, the UE may determine the spatial filter used for the PRACH transmission (initiated by the cell switch command) based on the SSB associated with the RACH information (e.g., the RACH occasion, the PRACH mask index, and/or the preamble index) indicated in the cell switch MAC CE. It should be noted each RACH configuration may be associated with one or more SSB indexes (or SSB configurations) during the RRC pre-configuration step. For example, each RRC configuration included in the candidate target cell configuration (e.g., LIM-Candidate) and/or the RRCReconfiguration message may be associated with one or more SSB indexes (or SSB configurations).

In some implementations, the UE may determine the pathloss reference signal used for calculating the transmission power of the PRACH transmission (initiated by the cell switch command) based on the TCI state indicated in the cell switch command. In some implementations, the UE may determine the pathloss PL_{b,f,c} on the UL BWP b of carrier f of target cell c for calculating the transmission power of the PRACH transmission based on at least one of the following reference signals associated with the TCI state indicated in the cell switch command:
1) source RS (or referenceSignal) associated with the TCI state indicated in the cell switch command (e.g., SSB, CSI-RS and/or TRS corresponding to the target cell); and
2) pathlossReferenceRS indicated in the TCI state configuration of the TCI state indicated in the cell switch command.

In some implementations, a cell switch MAC CE may include CFRA-related (or RACH configuration-related) information to indicate a UE to perform a RACH-based procedure for the target cell.

In some implementations, the TCI state described in the present disclosure may be a DL TCI state, a UL TCI state and/or a joint TCI state.

In some implementations, the UE may determine the pathloss reference signal used for calculating the transmission power of the PRACH transmission (initiated by the cell switch command) based on the SSB indicated in the cell switch command. In some implementations, the UE may determine the pathloss PL_{b,f,c} on the UL BWP b of carrier f of target cell c for calculating the transmission power of the PRACH transmission based on the SSB indicated in the cell switch command.

In some implementations, the UE may determine the pathloss reference signal used for calculating the transmission power of the PRACH transmission (initiated by the cell switch command) based on SSB associated with the RACH information (e.g., the RACH occasion, the PRACH mask index, and/or the preamble index) indicated in the cell switch MAC CE. In some implementations, the UE may determine the pathloss PL_{b,f,c} on the UL BWP b of carrier f of target cell c for calculating the transmission power of the PRACH transmission based on the SSB associated with the RACH information (e.g., RACH occasion, PRACH mask index, preamble index) indicated in the cell switch MAC CE. It should be noted each RACH configuration may be associated with one or more SSB indexes (or SSB configurations) during the RRC pre-configuration step. For example, each RRC configuration included in the candidate target cell configuration (e.g., LTM-Candidate) and/or the RRCReconfiguration message may be associated with one or more SSB indexes (or SSB configurations).

In some implementations, after a UE successfully received a cell switch MAC CE transmitted by the source cell/gNB, the UE may perform an RA procedure to the target cell based on the CFRA-related information (or RACH configuration-related) information indicated in the cell switch MAC CE, even though the UE has performed an LTM based PDCCH-ordered RA procedure for the target cell before receiving the cell switch MAC CE.

In some implementations, the CFRA-related (or RACH configuration-related) information indicated in the cell switch command may be a preamble index. The UE may determine the RACH configuration included in the candidate target cell configuration (e.g., LTM-Candidate) for the RA procedure performed with the target cell, based on the preamble index that is indicated in the cell switch command. Each RACH configuration included in the candidate target cell configuration may be associated with one or more preamble indexes.

In some implementations, the CFRA-related (or RACH configuration-related) information indicated in the cell switch command may be an SSB index. The UE may determine the RACH configuration included in the candidate target cell configuration (e.g., LTM-Candidate) for the RA procedure performed with the target cell, based on the SSB index indicated in the cell switch command. Each RACH configuration included in the candidate target cell configuration may be associated with one or more SSB indexes.

In some implementations, the CFRA-related (or RACH configuration-related) information indicated in the cell switch command may be a RACH configuration index. The UE may determine the RACH configuration included in the candidate target cell configuration (e.g., LTM-Candidate) for the RA procedure performed with the target cell, based on the RACH configuration index indicated in the cell switch command. Each RACH configuration included in the candidate target cell configuration may be associated with a RACH configuration index.

In some implementations, the cell switch MAC CE may include at least one of a preamble index field, a PRACH mask index field, and an SSB index field, to provide the CFRA-related information (or RACH configuration-related information).

Based on the CFRA-related information (or RACH configuration-related information) indicated in the cell switch MAC CE, and on the RACH configuration (e.g., ltm-EarlyUL-SyncConfig) included in the candidate target cell configuration (e.g., LTM-Candidate) of the target cell, the UE may perform an RA procedure with the target cell (e.g., after the UE successfully receives the cell switch MAC CE).

In some implementations, for a RACH-less scheme applied in the LTM procedure, the UE may acquire the TA of the target cell (e.g., a candidate target cell indicated in the cell switch command) without performing an RA procedure. The TA may be acquired based on at least one of:
1) a TA value (e.g., TA=0) in the TA field included in the cell switch command by the source cell/gNB;
2) the TA of the current serving cell/source cell; and
3) a UE-based TA measurement.

In some implementations, when (or after) the TA of the target cell (e.g., the candidate target cell indicated in the cell switch command) is acquired by the UE (e.g., via the RACH-less scheme or the RACH-based scheme), the UE may transmit first data (e.g., also referred to as first transmission) to the target cell on the PUSCH on the pre-configured UL resource(s) configured via RRC signaling (e.g., configured grant) or the dynamic UL resource(s) scheduled by the DCI/PDCCH (e.g., dynamic grant).

In some implementations, each candidate target cell may be associated with one or more CG configurations. For example, each candidate target cell configuration may include one or more CG configurations (or a list of CG configurations).

In some implementations, each candidate target cell may share the same set of CG configurations (or a list of CG configurations). For example, a common set (or list) of CG configurations may be shared by one or more candidate target cells configured to a UE for performing the LTM procedure. In some cases, the one or more candidate target cells may be the candidate target cells that are configured with a RACH-less scheme. In some cases, the one or more candidate target cells may be all the candidate target cells that are configured to the UE for performing the LTM procedure.

In some implementations, a dedicated CG configuration index (e.g., CG index=0) may be used to transmit the first transmission to the target cell.

In some implementations, the UE may determine to use a (UL) HARQ process (ID) for the PUSCH transmission of the first data.

In some implementations, the UE may identify a (UL) HARQ process (ID) to be used for the PUSCH transmission of the first data.

In a case that the PUSCH is configured via RRC signaling (e.g., the PUSCH is (to be) transmitted on pre-configured UL resource(s) or the PUSCH is transmitted using the configured grant), the UE may determine/identify the HARQ process (ID) based on the current (starting) symbol of the PUSCH transmission, the periodicity (e.g., which may be provided in the CG configuration,) and the number of HARQ processes configured (for configured-grant-based PUSCHs).

In some implementations, the current (starting) symbol may be calculated based on the (current) system frame number (SFN), the (current) slot number in the frame and the current symbol number in the slot.

In a case that the PUSCH is configured via RRC signaling (e.g., the PUSCH is (to be) transmitted on pre-configured UL resource(s) or the PUSCH is transmitted using the configured grant) and an HARQ process ID offset is provided in the CG configuration, the UE may determine/identify the HARQ process (ID) based on the current (starting) symbol of the PUSCH transmission, the periodicity (e.g., which may be provided in the CG configuration,) the number of HARQ processes configured (for configured-grant-based PUSCHs), and the HARQ process ID offset.

In some implementations, the current (starting) symbol may be calculated based on the (current) system frame number (SFN), the (current) slot number in the frame and the current symbol number in the slot.

In a case that the PUSCH is scheduled by a DCI/PDCCH, the UE may determine/identify the HARQ process (ID) based on the “HARQ process number” field included in the DCI/PDCCH.

In some implementations, after a UE receives a cell switch command successfully, the UE may transmit data (e.g., RRCReconfigurationComplete message) to the candidate target cell indicated in the cell switch command, where the data may be transmitted on a PUSCH on the pre-configured UL resource(s). In some implementations, the candidate target cell indicated in the cell switch command may be the target cell.

In some implementations, the UE may determine the spatial filter used for PUSCH transmission (corresponding to the first UL data transmission after the successful cell switch command reception) based on the source RS configured in the configuration of the TCI state (e.g., UL TCI state, DL TCI state and/or joint TCI state) indicated in the cell switch command. In some implementations, the source RS may be an SSB, a CSI-RS and/or a TRS.

In some implementations, the UE may determine the pathloss reference signal used for calculating the transmission power of PUSCH transmission (corresponding to the first UL data transmission after the successful cell switch command reception) based on the TCI state indicated in the cell switch command. For example, the UE may determine the pathloss PL_{b,f,c} on the UL BWP b of carrier f of target cell c for calculating the transmission power of the PUSCH transmission (corresponding to the first UL data transmission after the successful cell switch command reception) based on at least one of the following reference signals associated with the TCI state indicated in the cell switch command:
1) source RS (or referenceSignal) associated with the TCI state indicated in the cell switch command (e.g., an SSB, a CSI-RS and/or a TRS corresponding to the target cell); and
2) pathlossReferenceRS indicated in the TCI state configuration of the TCI state indicated in the cell switch command.

In some implementations, the UE may determine the pathloss reference signal used for calculating the transmission power of PUSCH transmission (corresponding to the first UL data transmission after the successful cell switch command reception) based on the SSB indicated in the cell switch command. For example, the UE may determine the pathloss PL_{b,f,c} on the UL BWP b of carrier f of target cell c for calculating the transmission power of PUSCH transmission (corresponding to the first UL data transmission after the successful cell switch command reception) based on the SSB indicated in the cell switch command.

In some implementations, the UE may determine the transmission power of the PUSCH transmission (corresponding to the first UL data transmission after the successful cell switch command reception) based on at least one of the following LTM dedicated RRC parameters/fields included in the CG configuration of the target cell: ltm-P0-PUSCH, and ltm-Alpha.

For example, the ltm-P0-PUSCH field may be used to indicate the PO value for the PUSCH transmission for the LTM procedure in steps of 1 dB. When the ltm-P0-PUSCH field is configured, the UE may ignore the p0-PUSCH-Alpha field included in the CG configuration.

For example, the ltm-Alpha field may be used to indicate the alpha value for PUSCH transmission. The ltm-Alpha field reads “alpha0” may indicate value 0 is used for calculating the transmission power of the PUSCH, the ltm-Alpha field reads “alpha4” may indicate value 4 is used for calculating the transmission power of the PUSCH, and so on. When the ltm-Alpha field is configured, the UE may ignore the p0-PUSCH-Alpha field included in the CG configuration.

In some implementations, after a UE receives a cell switch command successfully, the UE may transmit the data (e.g., RRCReconfigurationComplete message) to the candidate target cell indicated in the cell switch command, where the data may be transmitted on a PUSCH on the dynamic UL resource(s) (e.g., dynamic grant) scheduled by a DCI/PDCCH. In some implementations, the candidate target cell indicated in the cell switch command may be the target cell.

In some implementations, after a UE receives a cell switch command successfully, the UE may receive a DCI/PDCCH from the candidate target cell indicated in the cell switch command and then the UE may transmit the data (e.g., RRCReconfigurationComplete message) to the candidate target cell indicated in the cell switch command on the dynamic UL resource(s) scheduled by the DCI/PDCCH (e.g., the DCI/PDCCH may include an UL grant). In some implementations, the candidate target cell indicated in the cell switch command may be the target cell.

In some implementations, the UE may be provided with a USS set (by a SearchSpace field) included in the candidate target cell configuration of the target cell, or with a CSS set by an LTM dedicated CSS set or a Type3-PDCCH CSS set, to monitor a PDCCH for detection of a DCI format (e.g., DCI format 0_0) with CRC scrambled by a C-RNTI, a CS-RNTI and/or an LTM-specific RNTI after the UE successfully receives the cell switch command. The DCI format with CRC scrambled by the C-RNTI, the CS-RNTI and/or the LTM-specific RNTI may be used to schedule the PUSCH transmission. In some implementations, the LTM dedicated CSS set may be configured by an RRC field dedicated for the LTM (e.g., ltm-SearceSpace) in the PDCCH-ConfigCommon (included in the SIB1 corresponding to the target cell or source cell) for a DCI format with CRC scrambled by the C-RNTI, the CS-RNTI or the LTM-specific RNTI. In addition, the LTM dedicated CSS set may be configured on the target cell or source cell. It is also noted that the Type3-PDCCH CSS set may be configured by an RRC field (e.g., SearchSpace) in the PDCCH-Config with searchSpace Type=common for a DCI format with CRC scrambled by the C-RNTI, the CS-RNTI or the LTM-specific RNTI. In addition, the Type3-PDCCH CSS set may be configured on the target cell or source cell.

In some implementations, the LTM dedicated CSS set or the Type-3 PDCCH CSS set carrying the PDCCH for scheduling the new transmission may have the highest priority among other CSS set(s). In some implementations, the LTM dedicated CSS set or the Type-3 PDCCH CSS set carrying the PDCCH for scheduling the new transmission may correspond to the lowest SS set index.

In some implementations, after a UE successfully receives the cell switch command, the UE may determine the QCL assumptions based on the TCI state indicated in the cell switch command for the DM-RS of the PDCCH used to schedule the PUSCH transmission to transmit the data (e.g., RRCReconfigurationComplete message).

In some implementations, after a UE successfully receives the cell switch command, the UE may determine a UL transmission spatial filter based on the TCI state indicated in the cell switch command for a dynamic-grant and/or a configured-grant based PUSCH used to transmit the data (e.g., RRCReconfigurationComplete message).

In some implementations, after a UE successfully receives the cell switch command, the UE may determine the spatial domain transmission filter for the dynamic-grant and/or the configured-grant based PUSCH used to transmit the data (e.g., RRCReconfigurationComplete message) and/or may determine the QCL assumption of the DM-RS antenna port(s) associated with the PDCCH reception based on the TCI state indicated in the cell switch command. It should be noted the PDCCH may be used to schedule the PUSCH transmission for transmitting the data (e.g., RRCReconfigurationComplete message).

In some implementations, if the TA value indicated in the TA field included in the cell switch command is obtained by a UE via an LTM-based PDCCH-ordered RA procedure, after the UE successfully receives the cell switch command, the UE may transmit the first UL data (e.g., RRCReconfigurationComplete message) to the target cell by a dynamic-grant or a configured-grant based PUSCH transmission.

In some implementations, if the LTM procedure is completed/successful, the UE may receive a PDCCH, from the target cell, addressed to a C-RNTI indicating an uplink grant for a new transmission after transmitting the first UL data to the target cell. For example, the PDCCH may be received for the HARQ process used for the transmission of the first UL data.

In some implementations, if an RRC-configured timer (e.g., LTM supervisor timer) expires and the UE has not received the PDCCH (e.g., for the HARQ process used for the transmission of the first UL data) from the target cell, addressed to a C-RNTI indicating an uplink grant for a new transmission after transmitting the first UL data to the target cell, the UE may determine that the LTM procedure fails.

In some implementations, if the TA of target cell is obtained by the RACH-less scheme, after the UE successfully receives the cell switch command, the UE may transmit the first UL data (e.g., RRCReconfigurationComplete message) to the target cell by a dynamic-grant or a configured-grant based PUSCH transmission.

In some implementations, if the LTM procedure is completed/successful, the UE may receive the PDCCH (e.g., for the HARQ process used for the transmission of the first UL data), from the target cell, addressed to a C-RNTI indicating an uplink grant for a new transmission after transmitting the first UL data to the target cell before an RRC-configured timer (e.g., LTM supervisor timer) expires. In some implementations, an NDI is toggled in the PDCCH for scheduling the new transmission.

In some implementations, if an RRC-configured timer (e.g., LTM supervisor timer) expires and the UE has not received the PDCCH (e.g., for the HARQ process used for the transmission of the first UL data), from the target cell, addressed to a C-RNTI indicating an uplink grant for a new transmission after transmitting the first UL data to the target cell, the UE may determine that the LTM procedure fails.

In some implementations, if the LTM procedure is completed/successful, the UE may receive the PDCCH, from the target cell, addressed to a CS-RNTI activating a configured grant for a new transmission. In some implementations, the HARQ process used for the new transmission may be the same as the HARQ process used for the first data transmission by applying HARQ process offset value. In some implementations, the CS-RNTI may be provided in the candidate target cell configuration.

In some implementations, if the TA value indicated in the TA field included in the cell switch command is set to FFF (e.g., the TA value is invalid), the UE may perform an RA procedure (e.g., CFRA and/or CBRA) to obtain the TA value of target cell based on the RACH configuration included in the cell switch command, on the RACH configuration included in the candidate target cell RRC configuration of the target cell, and/or on the TCI state indicated in the cell switch command. If the RA procedure is completed before an RRC-configured timer (e.g., LTM supervisor timer) expires, the UE may determine that the LTM procedure is completed/successful. If the RA procedure is not completed before an RRC-configured timer (e.g., LTM supervisor timer) expires, the UE may determine that the LTM procedure fails.

In some implementations, a UE may receive one or more CG configurations, one or more TCI state lists associated with different candidate target cells, an RRC timer and one or more RRC fields associated with different candidate target cells, via RRC signaling from the source cell. Each CG configuration may include a CG index. Each TCI state may be associated with a CG configuration by including the CG index in the TCI state configuration. The RRC field or one of the RRC fields may be used to indicate whether the TA of the associated candidate target cell is similar to (or is the same as) the TA of the source cell. Afterwards, the UE may receive a cell switch command from the source cell. The cell switch command may include at least one of a TA field, a TCI state field and a candidate target cell index field. The TA field may be used to indicate a TA value of the target cell, the TCI state field may be used to indicate a TCI state of the target cell, and the candidate target cell index field may be used to indicate one of candidate target cell as the target cell.

In a case that a TA value of target cell indicated in a TA field included in the cell switch command is set to ‘0’, or the RRC field associated with the target cell indicates that the TA of the target cell is similar to (the same as) the TA of source cell, the UE may transmit a first UL data to the target cell based on a CG associated with the TCI state indicated in the cell switch command. The UE may determine a spatial transmission filter of a PUSCH transmission on the CG associated with the TCI state indicated in the cell switch command based on a source RS associated with the TCI state indicated in the cell switch command. The UE may determine the transmission power of the PUSCH transmission on the CG associated with the TCI state indicated in the cell switch command based on the source RS associated with the TCI state indicated in the cell switch command.

In a case that the UE receives a PDCCH (e.g., for the HARQ process used for the transmission of the first UL data), from the target cell, addressed to a C-RNTI indicating an uplink grant for a new transmission after transmitting the first UL data to the target cell and before the RRC timer expires, the UE may determine the LTM procedure is completed.

In a case that the UE does not receive the PDCCH (e.g., for the HARQ process used for the transmission of the first UL data), from the target cell, addressed to a C-RNTI indicating an uplink grant for a new transmission after transmitting the first UL data to the target cell and before the RRC timer expires, the UE may determine the LTM procedure fails.

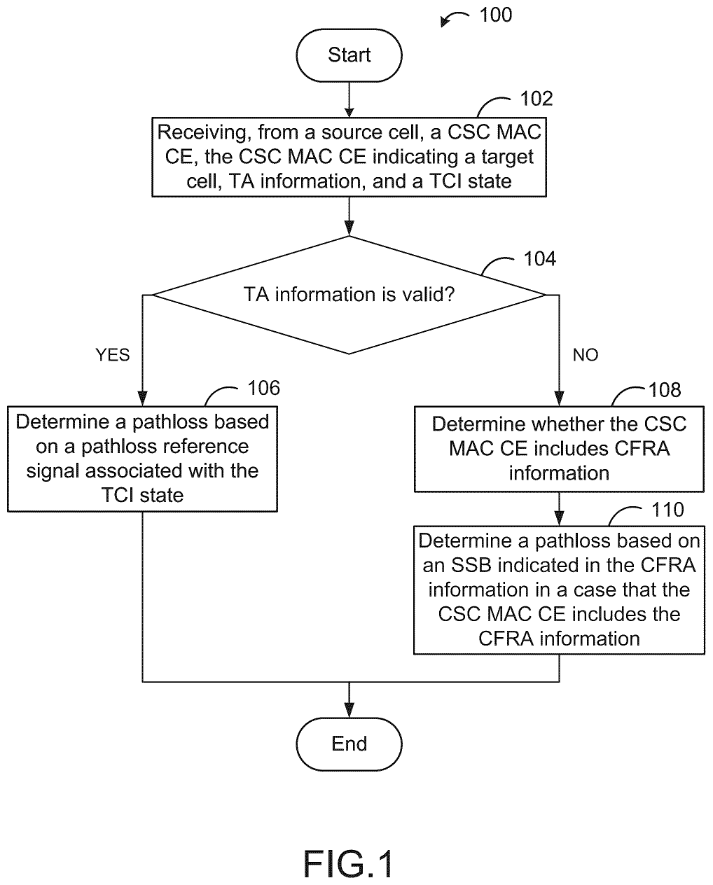

FIG. 1 is a flowchart illustrating a method/process 100 performed by a UE for LTM, according to an example implementation of the present disclosure.

In the action 102, the process 100 may start by receiving, from a source cell, a CSC MAC CE that indicates a target cell, TA information, and a TCI state. Specifically, the cell switch command may be a MAC CE that includes information of a target cell, TA, and a TCI state.

In some implementations, the target cell may be one of the candidate target cells configured to the UE.

In some implementations, the TA information may include a field including a value of the timing advance. In a case that the field includes a specific value (e.g., FFF), the TA information may be invalid, otherwise, the TA information may be valid.

In some implementations, the TCI state may include a UL TCI state, a DL TCI state, or a joint TCI state.

In the action 104, the process 100 may determine whether the TA information is valid. In a case that the TA information is determined to be valid, the process 100 may proceed to the action 106, otherwise, the process 100 may proceed to the action 108.

In some implementations, the validity of the TA information may be determined based on the value included in the field of the TA information. In a case that the field includes a specific value (e.g., FFF), the TA information may be determined to be invalid, otherwise, the TA information may be determined to be valid.

In action 106, the process 100 may determine a pathloss based on a pathloss reference signal associated with the TCI state. The process 100 may then end.

In some implementations, the pathloss reference signal may be provided by the pathlossReferenceRS field (e.g., indicated in the TCI state configuration of the TCI state indicated in the CSC MAC CE.

In some implementations, the RACH-less scheme may be applied by the UE. In other words, the UE may determine to perform a RACH-less cell switch procedure in a case that the TA information is determined to be valid in the action 104. In such a case, in the action 106, the UE may determine the pathloss based on the pathloss reference signal associated with the TCI state during the RACH-less cell switch procedure, where the determined pathloss may be associated with the transmission power of a PUSCH transmission to the target cell. In some implementations, the PUSCH transmission may be a first uplink transmission (e.g., of first UL data) to the target cell after receiving the CSC MAC CE from the source cell (e.g., after the action 102).

In the action 108, after determining that the TA information is invalid, the process 100 may determine whether the CSC MAC CE includes CFRA information (e.g., also referred to as CFRA-related information in this disclosure). In the action 110, the process 100 may determine a pathloss based on an SSB, indicated in the CFRA information, in a case that the CSC MAC CE includes the CFRA information. The process 100 may then end.

In some implementations, after determining that the TA information is invalid, the UE may first check whether the CSC MAC CE includes the CFRA (-related) information, then determine the pathloss based on the SSB indicated in the CFRA (-related) information.

In some implementations, the RACH-based scheme may be applied by the UE. In other words, the UE may determine to perform a RACH-based cell switch procedure in a case that the TA information is determined to be valid in the action 104. In such a case, the pathloss may be associated with the transmission power of the RA preamble (e.g., a PRACH triggered by the CSC MAC CE) in the RA procedure performed with the target cell, and thus the UE may perform an RA procedure with the target cell based on the transmission power (e.g., of the RA preamble/PRACH).

The steps/actions shown in FIG. 1 should not be construed as necessarily order dependent. The order in which the process is described is not intended to be construed as a limitation. Moreover, some of the actions shown in FIG. 1 may be omitted in some implementations and one or more actions shown in FIG. 1 may be combined.

The technical problem addressed by the method/process 100, as illustrated in FIG. 1, is to enhances the efficiency of the network resource utilization and to minimize the latency, resulting in ensuring that mobile users experience a seamless service continuity. By obtaining the required information for the LTM (e.g., the validity of the TA information and/or the pathloss) in various situations, the network may effectively manage the handovers, adjusting swiftly to the changes in signal quality. The use of LTM may also help in optimizing the allocation of network resources, which is essential for supporting high data rate applications and a growing number of users, thereby improving the overall network performance and user satisfaction.

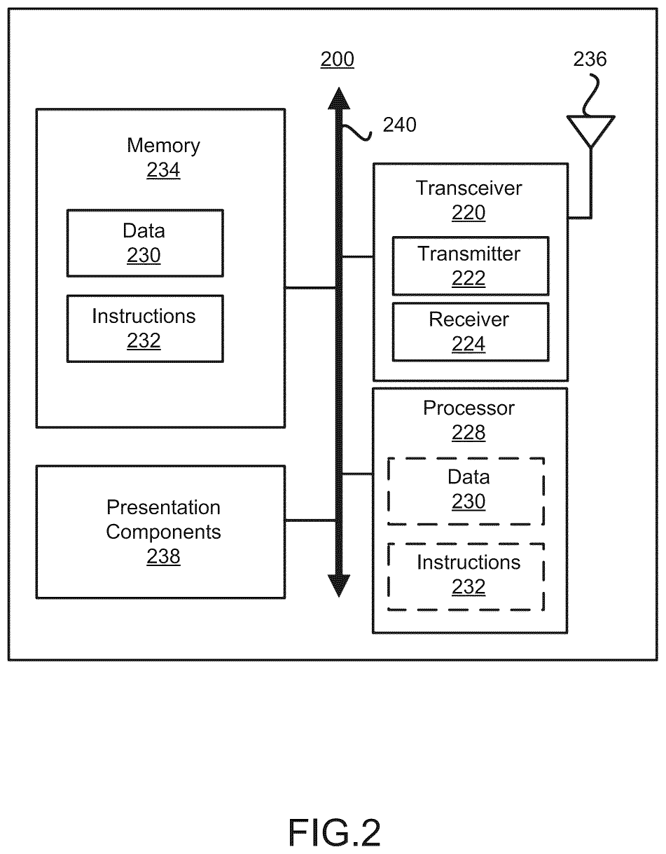

FIG. 2 is a block diagram illustrating a node 200 for wireless communication in accordance with various aspects of the present disclosure. As illustrated in FIG. 2, a node 200 may include a transceiver 220, a processor 228, a memory 234, one or more presentation components 238, and at least one antenna 236. The node 200 may also include a radio frequency (RF) spectrum band module, a BS communications module, a network communications module, and a system communications management module, Input/Output (I/O) ports, I/O components, and a power supply (not illustrated in FIG. 2).

Each of the components may directly or indirectly communicate with each other over one or more buses 240. The node 200 may be a UE or a BS that performs various functions disclosed with reference to FIG. 1.

The transceiver 220 has a transmitter 222 (e.g., transmitting/transmission circuitry) and a receiver 224 (e.g., receiving/reception circuitry) and may be configured to transmit and/or receive time and/or frequency resource partitioning information. The transceiver 220 may be configured to transmit in different types of subframes and slots including, but not limited to, usable, non-usable, and flexibly usable subframes and slot formats. The transceiver 220 may be configured to receive data and control channels.

The node 200 may include a variety of computer-readable media. Computer-readable media may be any available media that may be accessed by the node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 234 may include computer-storage media in the form of volatile and/or non-volatile memory. The memory 234 may be removable, non-removable, or a combination thereof. Example memory may include solid-state memory, hard drives, optical-disc drives, etc. As illustrated in FIG. 2, the memory 234 may store a computer-readable and/or computer-executable instructions 232 (e.g., software codes) that are configured to, when executed, cause the processor 228 to perform various functions disclosed herein, for example, with reference to FIG. 1. Alternatively, the instructions 232 may not be directly executable by the processor 228 but may be configured to cause the node 200 (e.g., when compiled and executed) to perform various functions disclosed herein.

The processor 228 (e.g., having processing circuitry) may include an intelligent hardware device, e.g., a Central Processing Unit (CPU), a microcontroller, an ASIC, etc. The processor 228 may include memory. The processor 228 may process the data 230 and the instructions 232 received from the memory 234, and information transmitted and received via the transceiver 220, the baseband communications module, and/or the network communications module. The processor 228 may also process information to send to the transceiver 220 for transmission via the antenna 236 to the network communications module for transmission to a CN.

One or more presentation components 238 may present data indications to a person or another device. Examples of presentation components 238 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for Layer 1/Layer 2 Triggered Mobility (LTM), the method comprising:
receiving, from a source cell, a Cell Switch Command (CSC) Medium Access Control (MAC) Control Element (CE), the CSC MAC CE indicating a target cell, Timing Advance (TA) information, and a Transmission Configuration Indicator (TCI) state;
determining whether the TA information is valid;
determining a pathloss based on a pathloss reference signal associated with the TCI state in a case that the TA information is valid;
determining whether the CSC MAC CE comprises Contention-Free Random Access (CFRA) information in a case that the TA information is not valid; and
determining the pathloss based on a Synchronized Signal Block (SSB) indicated in the CFRA information in a case that the CSC MAC CE comprises the CFRA information.

2. The method of claim 1, further comprising:
determining to perform a Random-Access Channel-less (RACH-less) cell switch procedure in a case that the TA information is valid,
wherein determining the pathloss based on the pathloss reference signal associated with the TCI state comprises determining the pathloss during the RACH-less cell switch procedure.

3. The method of claim 2, wherein the pathloss determined based on the pathloss reference signal associated with the TCI state during the RACH-less cell switch procedure is associated with a transmission power of a Physical Uplink Shared Channel (PUSCH) transmission to the target cell.

4. The method of claim 3, wherein the PUSCH transmission is a first uplink transmission to the target cell after receiving the CSC MAC CE from the source cell.

5. The method of claim 2, wherein the pathloss reference signal is provided by a pathlossReferenceRS field.

6. The method of claim 1, wherein the pathloss determined based on the SSB indicated in the CFRA information is associated with a transmission power of a Physical Random-Access Channel (PRACH) triggered by the CSC MAC CE.

7. The method of claim 6, further comprising:
performing a Random-Access procedure with the target cell based on the transmission power of the PRACH.

8. A User Equipment (UE) for Layer 1/Layer 2 Triggered Mobility (LTM), the UE comprising:
at least one processor; and
at least one non-transitory computer-readable medium coupled to the at least one processor and storing one or more computer-executable instructions that, when executed by the at least one processor, cause the UE to:
receive, from a source cell, a Cell Switch Command (CSC) Medium Access Control (MAC) Control Element (CE), the CSC MAC CE indicating a target cell, Timing Advance (TA) information, and a Transmission Configuration Indicator (TCI) state;
determine whether the TA information is valid;
determine a pathloss based on a pathloss reference signal associated with the TCI state in a case that the TA information is valid;
determine whether the CSC MAC CE comprises Contention-Free Random Access (CFRA) information in a case that the TA information is not valid; and
determine the pathloss based on a Synchronized Signal Block (SSB) indicated in the CFRA information in a case that the CSC MAC CE comprises the CFRA information.

9. The UE of claim 8, wherein the one or more computer-executable instructions, when executed by the at least one processor, further cause the UE to:
determine to perform a Random-Access Channel-less (RACH-less) cell switch procedure in a case that the TA information is valid,
wherein determining the pathloss based on the pathloss reference signal associated with the TCI state comprises determining the pathloss during the RACH-less cell switch procedure.

10. The UE of claim 9, wherein the pathloss determined based on the pathloss reference signal associated with the TCI state during the RACH-less cell switch procedure is associated with a transmission power of a Physical Uplink Shared Channel (PUSCH) transmission to the target cell.

11. The UE of claim 10, wherein the PUSCH transmission is a first uplink transmission to the target cell after receiving the CSC MAC CE from the source cell.

12. The UE of claim 9, wherein the pathloss reference signal is provided by a pathlossReferenceRS field.

13. The UE of claim 8, wherein the pathloss determined based on the SSB indicated in the CFRA information is associated with a transmission power of a Physical Random-Access Channel (PRACH) triggered by the CSC MAC CE.

14. The UE of claim 6, wherein the one or more computer-executable instructions, when executed by the at least one processor, further cause the UE to:
perform a Random-Access procedure with the target cell based on the transmission power of the PRACH.
